(19) United States
(12) Patent Application Publication
(10) Pub. No.: US 2015/0006374 A1
(43) Pub. Date: Jan. 1, 2015

(54) INFORMATION PROCESSING APPARATUS AND RECORDING MEDIUM

(71) Applicant: FUJI XEROX CO., LTD., Tokyo (JP)

(72) Inventor: Hiroyuki HASEGAWA, Kanagawa (JP)

(73) Assignee: FUJI XEROX CO., LTD., Tokyo (JP)

(21) Appl. No.: 14/201,254

(22) Filed: Mar. 7, 2014

(30) Foreign Application Priority Data
Jul. 1, 2013 (JP) 2013-137945

(51) Int. Cl. G06Q 20/14; G06Q 20/28

(52) U.S. Cl. CPC G06Q 20/14; G06Q 20/28
USPC 705/40

(57) ABSTRACT

An information processing apparatus includes a determining unit and a transmitting unit. The determining unit determines whether a user who uses a paid service, a charge for which is to be paid by a specific payment method, is able to pay the charge for the service by the specific payment method. In the case where the determining unit determines that the user is unable to pay the charge, the transmitting unit transmits a request data indicating a content of the request to a requested user who is requested to pay the charge for the service.

### CROSS-REFERENCE TO RELATED APPLICATIONS

This application is based on and claims priority under 35 USC 119 from Japanese Patent Application No. 2013-137945 filed Jul. 1, 2013.

### BACKGROUND

### Technical Field

The present invention relates to an information processing apparatus and a recording medium.

### SUMMARY

According to an aspect of the present invention, there is provided an information processing apparatus including: a determining unit that determines whether a user who uses a paid service, a charge for which is to be paid by a specific payment method, is able to pay the charge for the service by the specific payment method; and a transmitting unit that, in the case where the determining unit determines that the user is unable to pay the charge, transmits a request data indicating a content of the request to a requested user who is requested to pay the charge for the service.

### BRIEF DESCRIPTION OF THE DRAWINGS

Exemplary embodiments of the present invention will be described in detail based on the following figures, wherein:

FIG. 1 illustrates an example of the overall configuration of an information processing system according to a first exemplary embodiment;

FIG. 2 illustrates an example of the hardware configuration of an information processing apparatus 10;

FIG. 3 illustrates an example of the functional configuration of the information processing apparatus 10;

FIG. 4 illustrates an example of an image that allows selecting a payment method;

FIG. 5 illustrates an example of request conditions;

FIG. 6 illustrates an example of displayed request data;

FIG. 7 illustrates an example of a payment site;

FIG. 8 illustrates an example of an image displayed in the case where a payment is completed;

FIGS. 9A and 9B illustrate examples of displayed notification data;

FIG. 10 is a sequence diagram illustrating an example of operation of various devices during a request process;

FIG. 11 is a sequence diagram illustrating an example of operation of various devices during a providing process;

FIG. 12A illustrates an example of a first priority table;

FIG. 12B illustrates an example of a second priority table;

FIG. 13 illustrates an example of the functional configuration of an information processing apparatus according to a fourth exemplary embodiment;

FIG. 14 is a sequence diagram illustrating an example of operation of various devices during a request process; and

FIGS. 15A and 15B illustrate examples of request data used in a fifth exemplary embodiment.

### DETAILED DESCRIPTION

### [1] First Exemplary Embodiment

### [1-1] Overall Configuration

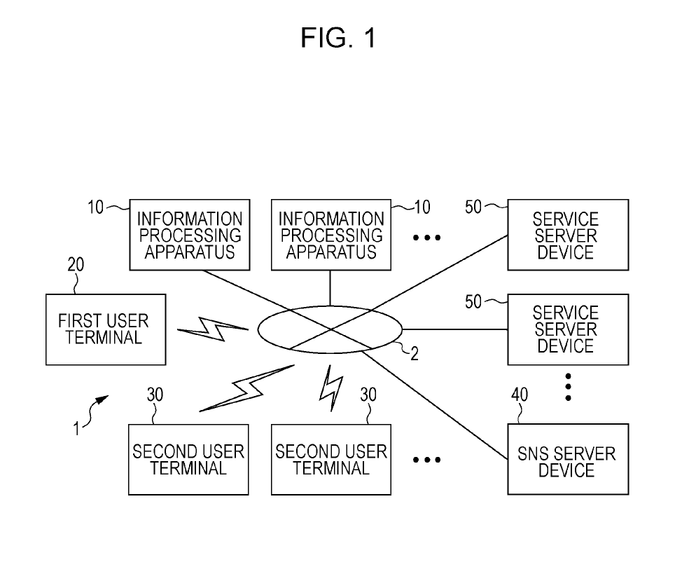

FIG. 1 illustrates an example of the overall configuration of an information processing system according to a first exemplary embodiment. FIG. 1 illustrates a network 2, an information processing system 1 including plural information processing apparatuses 10, a first user terminal 20, plural second user terminals 30, a social networking service (SNS) server device 40, and plural service server devices 50. The information processing system 1 is a system that provides a paid service (hereinafter referred to as a “paid service”) to a user and that performs a billing process for billing the user for a charge for the paid service (hereinafter referred to as a “service charge”). Examples of the paid service include a difference extraction service for extracting a difference between two pieces of data, a service for converting a data format, an optical character recognition (OCR) service, and a translation service.

In the information processing system 1, when a certain user uses a paid service, another user is occasionally requested to pay the service charge. In the following description, such a request to pay a service charge is referred to as a “payment request”. In addition, the user to whom a payment request is made (the user who is requested to make a payment) is referred to as a “requested user”, and users who are candidates for the requested user are referred to as “candidate users”. In the example of FIG. 1, the user uses the first user terminal 20, and the candidate users use the second user terminals 30. That is, the second user terminals 30 are also used by the requested user.

The first user terminal 20 and the second user terminals 30 are each a device such as a smartphone, a tablet terminal, and a personal computer. In the example of FIG. 1, the first user terminal 20 and the second user terminals 30 each perform wireless communication (for example, mobile communication or wireless local area network (LAN) communication) with the network 2. The terminals may perform wired communication with the network 2.

The network 2 is a system that performs communication including the Internet, a mobile communication network, and so forth, and mediates exchange of data between a device connected to the system and a device that performs wireless communication with the system. In the example of FIG. 1, the information processing apparatuses 10 and the SNS server device 40 are connected to the network 2. The SNS (social networking service) server device 40 is a device that provides an SNS to registered uses. In the exemplary embodiment, the term “SNS” refers to an SNS provided by the SNS server device 40. The SNS is used by the user and the candidate users. The SNS server device 40 stores information registered for the users (hereinafter referred to as “first registration information”), and provides the SNS to the users who log in on the basis of the first registered information (for example, a user ID and a password).

The service server devices 50 are each a device that performs a process such as difference extraction and data format conversion (hereinafter referred to as a “service process”) in the paid service such as the difference extraction service and the translation service. In the example of FIG. 1, the service server devices 50 are represented as single devices for ease of understanding of the description. However, such services may be provided as so-called cloud services. The service server devices 50 transmit result data indicating the result of the service process to the information processing apparatuses 10. Examples of the result data include data indicating an extracted difference and data indicating a translated document.

The plural information processing apparatuses 10 are each a device installed at a place visited by users such as a convenience store, and operated by a user who uses a paid service. The information processing apparatuses 10 receive an operation for selecting a paid service to use, and transmit demand data indicating a demand for execution of a process for providing the selected paid service to the service server devices 50. The service server devices 50 perform a process on the basis of the demand data, and transmit result data indicating the process result to the information processing apparatuses 10. The information processing apparatuses 10 output the result data transmitted from the service server devices 50. In this way, the paid service is provided to the user. The information processing apparatuses 10 also perform a billing process for a service charge for a provided paid service.

### [1-2] Hardware Configuration

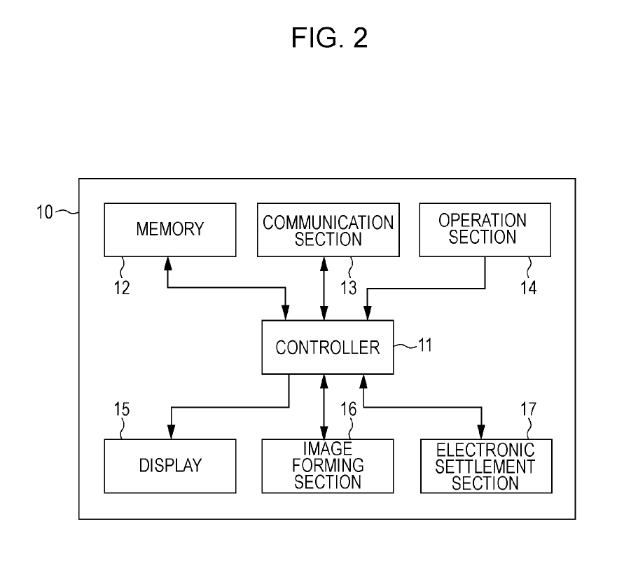

FIG. 2 illustrates an example of the hardware configuration of the information processing apparatus 10. The information processing apparatus 10 is a computer including a controller 11, a memory 12, a communication section 13, an operation section 14, a display 15, an image forming section 16, and an electronic settlement section 17. The controller 11 includes a central processing unit (CPU), a read only memory (ROM), a random access memory (RAM), and a real-time clock. The CPU executes a program stored in the ROM or the memory 12 using the RAM as a work area to control operation of the various sections. The real-time clock calculates a current time and date, and notifies the CPU of the time and date.

The memory 12 includes a hard disk drive or the like, and stores data, programs, image data, and so forth used for control performed by the controller 11. The memory 12 stores a process program for performing the billing process discussed above. The communication section 13 includes a communication circuit for performing communication, and communicates with an external device via the network 2, for example. The operation section 14 includes operators such as a touch panel and buttons, and receives an operation from a user performed on the operators. The operation section 14 supplies the controller 11 with operation data according to the received operation from the user. The controller 11 performs a process in accordance with the supplied operation data.

The display 15 includes a liquid crystal display or the like, and displays an image on a display surface. The touch panel of the operation section 14 is superposed on the display surface, which enables operation using an operator image representing an operator. The image forming section 16 is a unit that forms an image on a medium such as paper, and forms an image on paper by an electrophotographic system using toners in four colors, namely yellow (Y), magenta (M), cyan (C), and black (K), for example. The image forming section 16 outputs image data to a recording medium by forming an image indicated by the image data on the medium when a facsimile function or an image forming function is executed, for example.

The electronic settlement section 17 is a device that makes electronic settlement by performing near field communication (NFC) in accordance with an NFC standard with an integrated circuit (IC) card for electronic settlement possessed by a user and including an NFC chip. The electronic settlement section 17 is connected to an electronic settlement system (not illustrated), and performs an electronic settlement process on the basis of an IC card number and credit information read from the IC card through the NFC. Data indicating that a payment is completed (hereinafter referred to as “settlement completion data”) are transmitted from the electronic settlement system to the electronic settlement section 17. The electronic settlement section 17 supplies the controller 11 with the received settlement completion data.

### [1-3] Functional Configuration

The information processing system 1 performs the billing process discussed above on the basis of the hardware configuration described above. The controller 11 of the information processing apparatus 10 controls the various sections by executing the process program stored in the memory 12 to implement the functions discussed below.

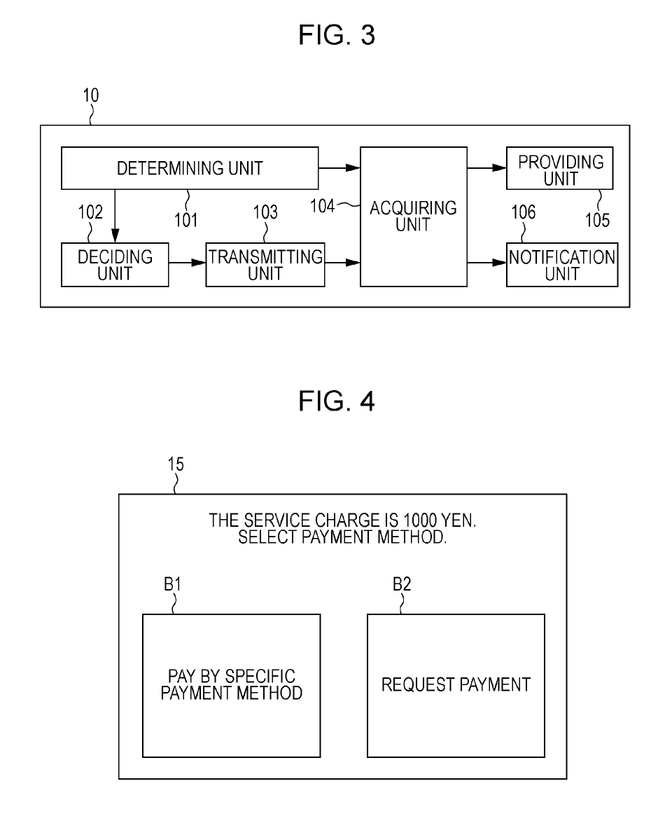

FIG. 3 illustrates an example of the functional configuration of the information processing apparatus 10. The information processing apparatus 10 includes a determining unit 101, a deciding unit 102, a transmitting unit 103, an acquiring unit 104, a providing unit 105, and a notification unit 106.

[1-3-1] Determining Unit 101

The determining unit 101 is an example of a unit that determines whether a user who uses a paid service, the charge for which is to be paid by a specific payment method, is able to pay the service charge (that is, the charge for the paid service) by the specific method. Examples of the specific payment method include payment by electronic settlement operated by a specific business. In the exemplary embodiment, the specific payment method is a payment method in which a payment may be made using a corresponding IC card only. The determining unit 101 is a function implemented by the controller 11, the memory 12, the operation section 14, and the display 15, for example.

In the exemplary embodiment, a paid service is provided to registered users, and the memory 12 stores information registered for the users (hereinafter referred to as “second registered information”, which is different from the first registered information discussed earlier). Examples of the second registered information include a user ID and a password. When the operation section 14 is operated to input a user ID and a password, the controller 11 recognizes the user for whom the second registered information including the input user ID and password has been registered as a user, and provides the paid service to the user. Specifically, when the user performs an operation for utilizing the paid service, the controller 11 decides the content of the paid service to be provided on the basis of the content of the operation.

The operation is performed before a payment for the service charge, and hereinafter referred to as a “pre-payment operation”. When the content of the paid service is decided by the pre-payment operation, the controller 11 issues a number for identifying the paid service (hereinafter referred to as a “service number”), and causes the memory 12 to store the service number in correlation with the decided content. The service number is used to identify which service a request for a payment or completion of a payment corresponds to. In addition, the controller 11 calculates a service charge on the basis of the decided content of the paid service, and causes the display 15 to display an image that allows selecting a payment method for the calculated service charge.

FIG. 4 illustrates an example of the image that allows selecting a payment method. In the example, the display 15 displays a character string “THE SERVICE CHARGE IS 1000 YEN. PLEASE SELECT PAYMENT METHOD.”, an operator image B1 including a character string “PAY BY THE SPECIFIC PAYMENT METHOD”, and an operator image B2 including a character string “REQUEST PAYMENT”. In the case where operation data indicating that the operator image B1 is selected are supplied from the operation section 14, the controller 11 determines that the user is able to make a payment by the specific payment method. In the case where operation data indicating that the operator image B2 is selected, the controller 11 determines that the user is unable to make a payment by the specific payment method. In the case where it is determined that the payment may not be made by the specific payment method as a result of the determination, the determining unit 101 supplies the deciding unit 102 with the user ID of the user for whom the determination is made, for example, together with the service number.

In the case where the determining unit 101 determines that the user may make the payment by the specific payment method, the controller 11 causes the display 15 to display a character string “HOLD AN IC CARD AT APPROPRIATE POSITION”, for example. When the user holds an IC card close to the electronic settlement section 17 to start NFC, an electronic settlement process is performed on the basis of the IC card number and the credit information read from the IC card. For example, the controller 11 transmits data indicating the read IC card number (that is, the IC card number of the user) and the service charge to an electronic settlement system used for the specific payment method. Consequently, electronic settlement for a case where the user himself/herself pays the service charge is made. In the case where it is determined that the payment may be made by the specific payment method, the determining unit 101 notifies the acquiring unit 104 of such a determination result together with the service number.

[1-3-2] Deciding Unit 102

The deciding unit 102 is an example of a unit that decides a requested user (a candidate user to which a payment request is made) from the candidate users discussed above on the basis of information that may affect the payment request (hereinafter referred to as “affecting information”). More particularly, the affecting information is information that may affect decision on a person to which a payment request is made (requested user). If the affecting information is different, the person to which a payment request is made may also be different. In the exemplary embodiment, the deciding unit 102 decides a requested user using the attribute of the candidate users as the affecting information. The deciding unit 102 is a function implemented by the controller 11, the memory 12, and the communication section 13, for example.

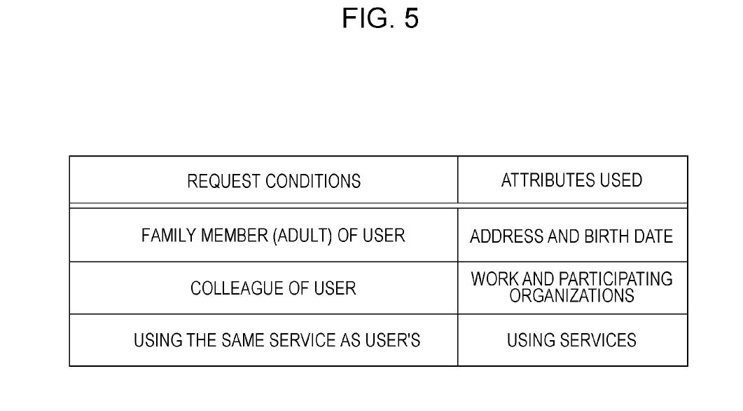

The second registered information stored in the memory 12 includes information representing the attribute of users such as the user and the candidate users. Examples of the attribute of users include the address, the birth date, the work, participating organizations (organizations to which he/she belongs), and using services (services which he/she uses such as an SNS and a mail-order trading service). The controller 11 determines using the attributes whether or not conditions determined in advance are met. In the case where such conditions are met, the controller 11 decides the candidate user with such attributes as the requested user. The conditions for deciding the requested user when such conditions are met are hereinafter referred to as “request conditions”. An example of the request conditions and the attributes used for the request conditions will be described with reference to FIG. 5.

FIG. 5 illustrates an example of the request conditions. In the example, it is indicated that the attributes “ADDRESS AND BIRTH DATE”, “WORK AND PARTICIPATING ORGANIZATIONS”, and “USING SERVICES” are used for the request conditions “FAMILY MEMBER (ADULT) OF USER”, “COLLEAGUE OF USER”, and “USING THE SAME SERVICE AS USER'S”, respectively. For example, in the case where the attribute of a certain candidate user indicates that the candidate user has the same address as the user's and is 20 years of age or older, the controller 11 determines that the candidate user meets the request conditions, and decides him/her as the requested user. In addition, in the case where the attribute of a certain candidate user indicates that the candidate user has the same work and participating organizations as the user's, and in the case where the candidate user uses the same services as the user's, the controller 11 determines that the candidate user meets the request conditions, and decides him/her as the requested user. The deciding unit 102 decides the requested user in this way, and supplies the transmitting unit 103 with the user ID included in the second registered information, for example, as information for identifying the decided requested user together with the service number.

[1-3-3] Transmitting Unit 103

The transmitting unit 103 is an example of a unit that, in the case where the determining unit 101 determines that a service charge may not be paid, transmits to an address corresponding to the requested user who is a person requested to pay the service charge data indicating the content of the request (hereinafter referred to “request data”). More particularly, the transmitting unit 103 transmits the request data to an address corresponding to the requested user decided by the deciding unit 102. The transmitting unit 103 is a function implemented by the controller 11, the memory 12, and the communication section 13, for example.

Examples of the address corresponding to the requested user include an electronic mail address of the requested user and an SNS account of the requested user. In the exemplary embodiment, the memory 12 stores an account used for an SNS (SNS provided by the SNS server device 40) by the candidate users as the second registered information. When the user ID is supplied from the deciding unit 102, the controller 11 transmits the request data together with the service number to the account included in the second registered information including the supplied user ID via the communication section 13. After transmitting the request data in this way, the transmitting unit 103 notifies the acquiring unit 104 of such transmission together with the service number.

In the case where plural requested users are decided by the deciding unit 102, the transmitting unit 103 may transmit the request data to all of the requested users, or may transmit the request data only to one of the requested users selected by the user. In the former case, the transmitting unit 103 transmits the request data to plural addresses corresponding to the plural decided requested users. In the latter case, the transmitting unit 103 displays an image that allows the user to select one of the decided requested users, and transmits the request data to an address corresponding to the requested user selected by the user.

Examples of the request data include data indicating a sentence requesting a payment and a uniform resource locator (URL) of a site used to make the payment (hereinafter referred to as a “payment site”). In the exemplary embodiment, the SNS server device 40 provides the payment site. The payment site is a site for making a payment involved in utilizing the SNS, and is provided as a service of the SNS. When the request data are posted on the SNS, the content of the request data posted on the account of the user is displayed when the user logs in to the SNS using the first user terminal 20, for example.

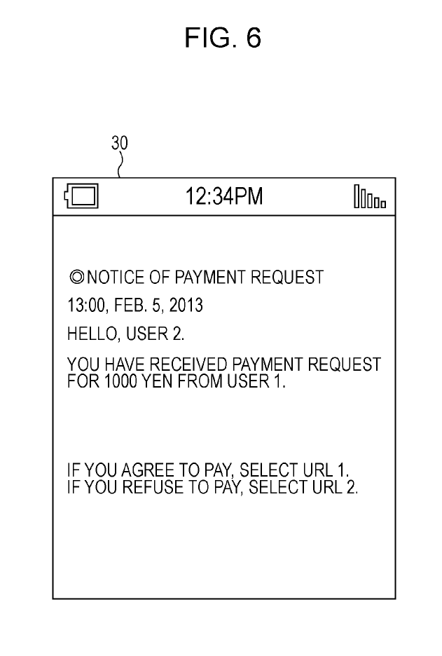

FIG. 6 illustrates an example of the displayed request data.

In the example, request data represented by character strings “NOTICE OF PAYMENT REQUEST”, “HELLO, USER 2. YOU HAVE RECEIVED PAYMENT REQUEST FOR 1000 YEN FROM USER 1.”, and “IF YOU AGREE TO PAY, SELECT URL 1. IF YOU REFUSE TO PAY, SELECT URL 2.” The corresponding actual URLs are displayed in place of “URL 1” and “URL 2” so that a site at the selected URL is displayed when the requested user selects one of “URL 1” and “URL 2”. If the requested user selects the URL 2, the second user terminal 30 transmits refusal data indicating that the payment is refused, for example, to the information processing apparatus 10 and the first user terminal 20 together with the service number.

If the requested user selects the URL 1, the second user terminal 30 displays the payment site discussed earlier.

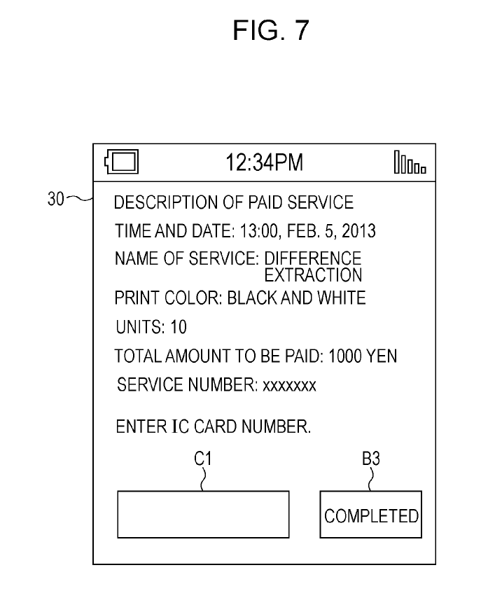

FIG. 7 illustrates an example of the payment site. In the example, the second user terminal 30 displays character strings including “DESCRIPTION OF PAID SERVICE”, “TOTAL AMOUNT TO BE PAID: 1000 YEN”, and “SERVICE NUMBER: xxxxxxx”, a character string “ENTER IC CARD NUMBER”, an input field C1 for entry of an IC card number, and an operator image B3 for completion of entry. The service number is the number assigned by the controller 11 to each service that the user desires to use through the pre-payment operation discussed above.

When the requested user inputs the number of an IC card possessed by himself/herself in the input field C1 and selects the operator image B3, data indicating the input IC card number (that is, the IC card number of the requested user) and the service charge are transmitted to an electronic settlement system used for the specific payment method, and the requested payment for the service charge is made. When the electronic settlement system completes settlement, the settlement completion data discussed above (data indicating that the payment is completed) are transmitted to the SNS server device 40. The SNS server device 40 posts a notice indicating that the payment is completed, for example, together with the service number on the payment site.

[1-3-4] Acquiring Unit 104

The acquiring unit 104 is an example of a unit that acquires information (hereinafter referred to as “status information”) indicating the status of a payment (hereinafter referred to as a “payment status”) for a service charge for a paid service used by the user. The acquiring unit 104 is a function implemented by the controller 11, the memory 12, and the communication section 13, for example. In the case where the determining unit 101 determines that the payment may be made by the specific payment method, the determining unit 101 notifies the controller 11 of such a determination result together with the service number. In this case, when settlement completion data are supplied from the electronic settlement section 17, the controller 11 acquires the supplied settlement completion data and the service number provided earlier as the status information indicating that the payment corresponding to the service number (that is, the payment for the service charge for the paid service identified by the service number) is completed.

In the case where the determining unit 101 determines that the payment may not be made by the specific payment method, meanwhile, the controller 11 is notified that request data are transmitted from the transmitting unit 103. In this case, the controller 11 accesses the payment site discussed earlier, for example, and in the case where data indicating that the payment is completed are transmitted together with the provided service number, acquires such data as the status information indicating that the payment corresponding to the service number is completed. The acquiring unit 104 acquires the status information in this way, and in the case where status information indicating that a payment for a service charge is completed is acquired, notifies the providing unit 105 and the notification unit 106 of a fact that the payment for the service charge is completed together with the service number corresponding to the payment.

[1-3-5] Providing Unit 105

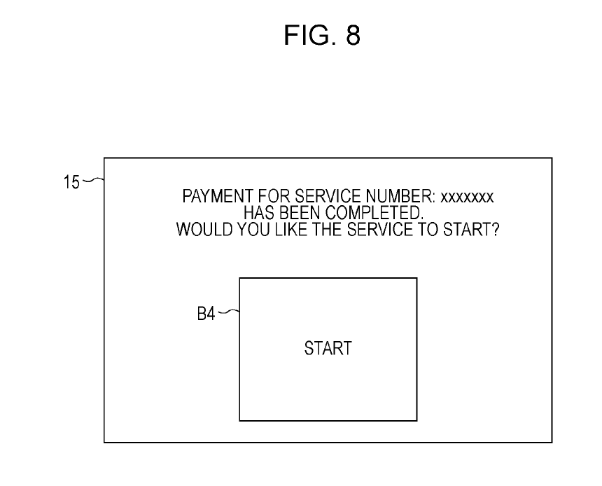

The providing unit 105 is an example of a unit that provides a paid service to a user in the case where the acquiring unit 104 acquires status information indicating that a payment for a service charge is completed. The providing unit 105 is a function implemented by the controller 11, the memory 12, the communication section 13, the operation section 14, the display 15, and the image forming section 16, for example. When the user operates the operation section 14 to input a service number, the controller 11 causes the display 15 to display an image illustrated in FIG. 8, for example, if the controller 11 is notified that the payment corresponding to the input service number is completed.

FIG. 8 illustrates an example of an image displayed in the case where a payment for a paid service is completed. In the example, a character string “PAYMENT FOR SERVICE NUMBER: xxxxxxx HAS BEEN COMPLETED. WOULD YOU LIKE THE SERVICE TO START?” and an operator image B4 including a character string “START” are displayed. When an operation for selecting the operator image B4 is performed, the controller 11 performs a process for providing a paid service with a content stored in correlation with the service number. In the case where the difference extraction service is selected and two pieces of data between which a difference is to be extracted are designated in the pre-payment operation, for example, the controller 11 transmits the designated two pieces of data and data indicating that extraction of a difference between such pieces of data is demanded to the service server device 50 as the demand data discussed above (data demanding execution of a process for providing a paid service).

When the demand data are received, the service server device 50 extracts a difference between the two pieces of data indicated by the demand data, and transmits result data indicating the extraction result (in this case, data indicating the extracted difference) to the information processing apparatus 10. The controller 11 controls the image forming section 16 to form the result data transmitted from the service server devices 50 on a medium. With an image representing the difference formed on the medium in this way, the difference extraction service is provided to the user. The providing unit 105 provides the paid service as described above.

The providing unit 105 may transmit demand data to the service server device 50 and receive result data in advance when a pre-payment operation is performed, and only output the result data when a payment is completed and a service number is input.

[1-3-6] Notification Unit 106

The notification unit 106 is an example of a unit that notifies the user of the payment status of the service charge acquired by the acquiring unit 104. The notification unit 106 is a function implemented by the controller 11 and the communication section 13, for example. When notified by the acquiring unit 104 of the service number and a fact that the payment corresponding to the service number is completed, the controller 11 transmits data for notifying the user of such a fact (hereinafter referred to as “notification data”) to the first user terminal 20 via the communication section 13. The first user terminal 20 displays the notification data transmitted from the information processing apparatus 10.

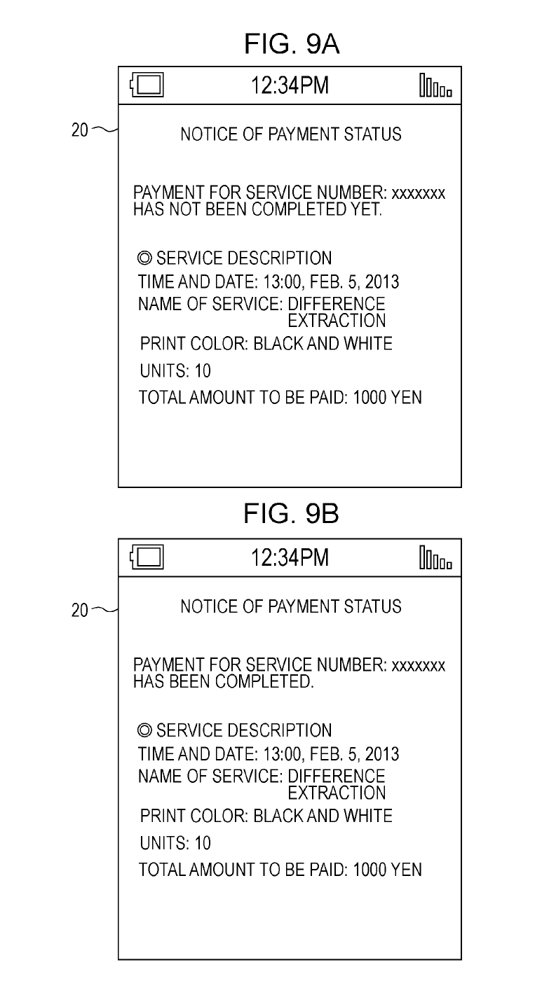

FIGS. 9A and 9B each illustrate an example of the displayed notification data. In the example illustrated in FIG. 9A, the first user terminal 20 displays a character string for the title “NOTICE OF PAYMENT STATUS”, a character string “PAYMENT FOR SERVICE NUMBER: xxxxxxx HAS NOT BEEN COMPLETED YET.”, and character strings representing the content of the service. In the example illustrated in FIG. 9B, unlike FIG. 9A, a character string “PAYMENT FOR SERVICE NUMBER: xxxxxxx HAS BEEN COMPLETED.” is displayed. When the notification unit 106 transmits the notification data in this way, the user is notified of the acquired payment status. Specifically, the user is notified of a payment status that a payment has not been completed in the example of FIG. 9A, and of a payment status that a payment has been completed in the example of FIG. 9B.

The notification unit 106 may notify the user of the content of notification data, that is, the payment status of a service charge, by transmitting the notification data to an SNS account or an electronic mail address of the user. In this case, the user is notified of the payment status by the function of the SNS or the mail software to inform the user of a new post or mail. The notification unit 106 may make a notification by telephone, or may use plural notification methods described so far.

### [1-4] Operation

The information processing system 1 performs the billing process discussed above (a process for billing the user for a service charge) on the basis of the configuration described above. In the following description, the billing process is divided into a request process related to a payment request and a providing process related to providing a paid service.

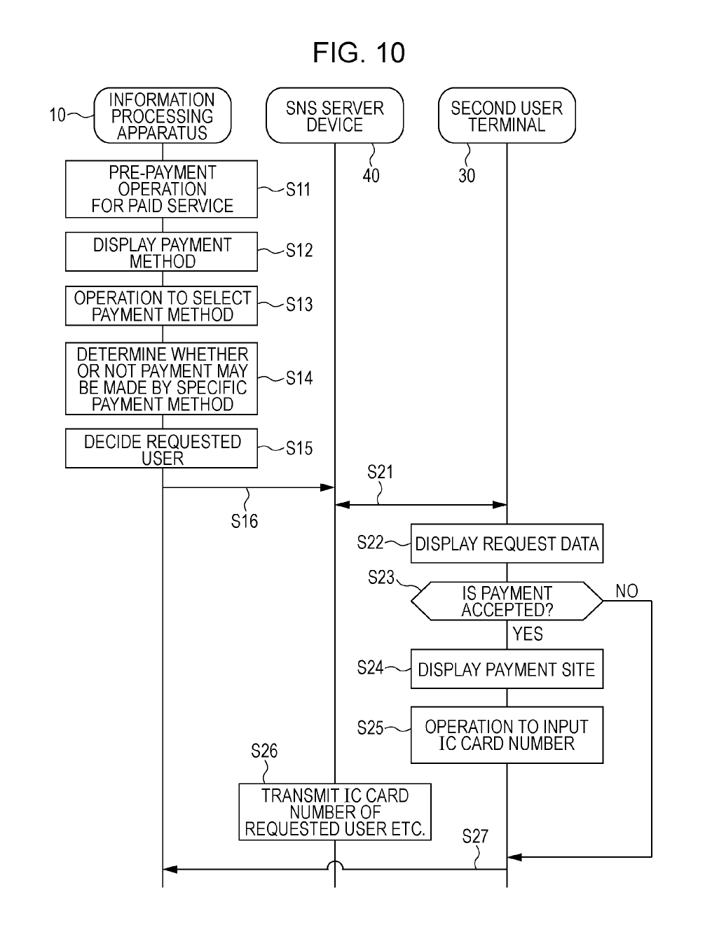

FIG. 10 is a sequence diagram illustrating an example of operation of various devices during the request process. The request process is started with reception of the pre-payment operation discussed above (an operation performed before a payment for the service charge) by the information processing apparatus 10 (step S11) as an impetus.

Next, the information processing apparatus 10 displays the service charge for a paid service that the user desires to use and a payment method as illustrated in FIG. 4 (step S12). Subsequently, the information processing apparatus 10 receives an operation performed by the user to select a payment method (a select operation) (step S13). In the example illustrated in FIG. 4, the information processing apparatus 10 receives either an operation to select the operator image B1 or an operation to select the operator image B2. Then, the information processing apparatus 10 determines whether or not the payment is made by the specific payment method (step S14). In the example illustrated in FIG. 4, the information processing apparatus 10 determines that the payment may be made by the specific payment method in the case where an operation to select the operator image B1 is received, and determines that the payment may not be made by the specific payment method in the case where an operation to select the operator image B2 is received. Steps S12, S13, and S14 are performed by the determining unit 101.

In the case where it is determined in step S14 that the payment may be made by the specific payment method, the payment for the service charge is made by the specific payment method by the user by holding an IC card close to the electronic settlement section 17, for example, and the information processing apparatus 10 provides the paid service. In FIG. 10, operation for this case is omitted, and operation for a case where it is determined in step S14 that the payment may not be made by the specific payment method is described.

In the case where it is determined that the payment may not be made by the specific payment method, the information processing apparatus 10 decides a requested user who is a person requested to make the payment (step S15). Step S15 is performed by the deciding unit 102. Next, the information processing apparatus 10 transmits request data to an address corresponding to the decided requested user (step S16). In the example of FIG. 10, the information processing apparatus 10 transmits the request data to the SNS server device 40 by posting the request data to an account of the requested user.

When the request data are received in step S16, the SNS server device 40 stores the request data in correlation with the account to which the request data are posted. The SNS server device 40 provides an SNS to the requested user by exchanging data with the second user terminal 30 which logs in using the account (step S21). Steps S22 to S25 performed thereafter are performed by the second user terminal 30 while exchanging data with the SNS server device 40.

In the example of FIG. 10, the second user terminal 30 displays the request data illustrated in FIG. 6 (step S22). Next, the second user terminal 30 determines whether or not the requested user agrees to make the payment (step S23). In the example of FIG. 6, the second user terminal 30 determines that the payment is accepted in the case where the URL 1 is selected, and determines that the payment is refused in the case where the URL 2 is selected. In the case where it is determined that the payment is accepted (YES), the second user terminal 30 displays the payment site illustrated in FIG. 7, for example (step S24).

Subsequently, when the second user terminal 30 receives an operation to input the IC card number of the requested user (an input operation) (step S25), the SNS server device 40 transmits data such as the input IC card number of the requested user to an electronic settlement system used for the specific payment method (step S26). Consequently, the service charge for the paid service used by the user is settled by the electronic settlement system, and paid by the specific payment method.

In the case where it is determined in step S23 that the payment request is refused (NO) (the URL 2 is selected in the example of FIG. 6), meanwhile, the second user terminal 30 transmits the refusal data discussed above (data indicating that the payment is refused) to the information processing apparatus 10 and the first user terminal 20 (not illustrated) (step S27).

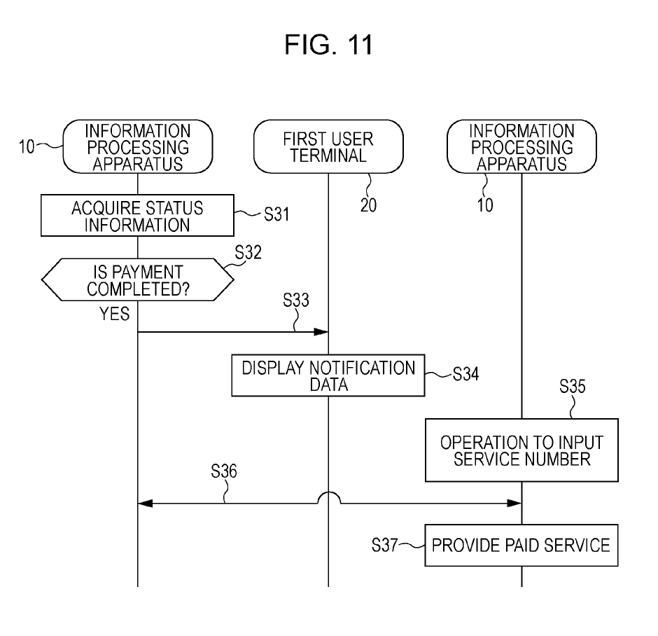

FIG. 11 is a sequence diagram illustrating an example of operation of various devices during the providing process. The providing process is started with acquisition of the status information discussed above (information indicating the payment status of the service charge) by the information processing apparatus 10 (step S31) as an impetus. Step S31 is performed by the acquiring unit 104. Next, the information processing apparatus 10 determines on the basis of the acquired status information whether or not the payment is completed (step S32). In the case where the payment is completed (YES), the information processing apparatus 10 transmits the notification data discussed above (data indicating the service number and that the payment corresponding to the service number is completed) to the first user terminal 20 (step S33). Steps S32 and S33 are performed by the notification unit 106. The first user terminal 20 displays the notification data received in step S33 (for example, the notification data illustrated in FIG. 9B) (step S34).

The user is informed from the displayed notification data that the payment for the service charge is completed, and moves to a location at which the information processing apparatus 10 is installed to be provided with the paid service. The information processing apparatus 10 in this case may be the information processing apparatus 10 on which an operation for use is performed in step S11 illustrated in FIG. 10, or may be another information processing apparatus 10. FIG. 11 illustrates a case where a different information processing apparatus 10 provides the paid service. When an operation to input a service number performed by the user is received (step S35), the different information processing apparatus 10 makes an inquiry to the other information processing apparatuses 10 about the content of the paid service identified by the service number (step S36), and provides the paid service in accordance with the content of a reply (step S37). Specifically, the information processing apparatus 10 provides the paid service by transmitting demand data to the service server device 50 (not illustrated) and outputting result data transmitted in return. Steps S34, S35, and S36 are performed by the providing unit 105.

### [2] Second Exemplary Embodiment

A second exemplary embodiment of the present invention will be described below with focus on differences from the first exemplary embodiment. Although the attribute of the candidate users is used as the affecting information in the first exemplary embodiment, four types of affecting information that are different from the attribute of the candidate users are used in the second exemplary embodiment. Four decision methods for deciding a requested user on the basis of such types of affecting information will be sequentially described below.

### [2-1] Second Decision Method

In a second decision method, the deciding unit 102 decides a requested user using a history of interaction between the user and a candidate user as the affecting information. The history of interaction is represented by the number of posts made to the account of the user on the SNS in the past (referred to as a “number of past posts”), the frequency of the posts made in a prescribed period (such as one year in the past) (referred to as “posting frequency”), or the like, for example. The deciding unit 102 decides a candidate user with a number of past posts of a threshold (for example, 100) or more as the requested user, or decides a candidate user with a posting frequency of a threshold (for example, 30) or more as the requested user, for example. In this way, the deciding unit 102 determines whether or not certain conditions (conditions for deciding the requested user when such conditions are met, or the request conditions discussed above) are met using the history of interaction between the user and a candidate user, and decides the candidate user as the requested user in the case where such conditions are met.

In this case, in order to reference exchange of posts between the user and the requested user, the deciding unit 102 logs in to the SNS using an account specifically registered for a paid service, for example. Each user may make settings for the account such that posts to himself/herself may be referenced, which allows the deciding unit 102 to make a decision on the basis of the history of interaction. Such an account may not be used, and the user may input his/her own account in the pre-payment operation. In this case, the deciding unit 102 logs in to the SNS using the account of the user to reference exchange of posts between the user and the requested user.

Some SNSs are set such that persons with much interaction are recognized. For example, some SNSs may be set such that all the attribute information on users is viewable, or may be set such that exchange with other users is viewable. The deciding unit 102 may determine that the request conditions are met in the case where such settings are made.

The user may be on closer terms with, and therefore feel more comfortable to request a payment to, a candidate user with more interaction. In such a case, if the second decision method is used as in the example described above, for example, a candidate user with more interaction is more likely to be decided as the requested user than candidate users with less interaction.

### [2-2] Third Decision Method

In a third decision method, the deciding unit 102 decides a requested user using a paying capacity of a candidate user by the specific payment method as the affecting information. The paying capacity is represented by whether or not the candidate user is registered to a payment site used for the specific payment method, whether or not the candidate user has an IC card used for the specific payment method, the balance of his/her account used for the specific payment method, or the like, for example. The deciding unit 102 decides a candidate user registered to the payment site or a candidate user that possesses the IC card as the requested user, for example. In such cases, the deciding unit 102 uses whether or not the candidate user is registered or whether or not the candidate user possesses the IC card as the request conditions. The deciding unit 102 determines such request conditions using information registered by the user as one piece of the second registered information, for example. In addition, the deciding unit 102 may determine such request conditions by storing a fact that the user made a payment by the specific payment method in the past in correlation with the user ID of the user.

In addition, the deciding unit 102 has an account and a password of a candidate user for an SNS registered as the second registered information in the case where the SNS discloses the balance of an account that may be used for the payment site, for example, and accesses the SNS server device 40 using such information to reference the balance of the account of the candidate user. In the case where the referenced balance of the account is the service charge or more, the deciding unit 102 determines that the request conditions are met, and decides the candidate user as the requested user.

It is a matter of course that if a candidate user having no paying capacity is requested to make a payment, he/she is unable to make the payment. If the third decision method is used as in the example described above, for example, a candidate user having a paying capacity is decided as the requested user.

The deciding unit 102 may reference the balance of an account, for example, to decide the candidate user with the highest paying capacity, among candidate users with a paying capacity, as the requested user. This makes it more likely that a request for a payment is accepted compared to a case where such a decision is not made, because a person with a sufficient paying capacity for a service charge tends to agree to make a payment. In addition, the deciding unit 102 may decide the candidate user who accepted payment requests in the past to make payments the largest number of times or for the largest total of service charges as the requested user.

### [2-3] Fourth Decision Method

In a fourth decision method, the deciding unit 102 decides a requested user using state information of a candidate user about a service to be utilized via a network (hereinafter referred to as a “network service”) as the affecting information. Examples of the network service include an SNS and a mail-order trading service. For a service that involves a login, examples of the state information about a network service include whether or not a candidate user logs in. The deciding unit 102 accesses a network service, for example, determines that the request conditions are met in the case where the account of the candidate user stored as the second registered information is logged in to, and decides the candidate user as the requested user.

When the candidate user is utilizing a network service, it is highly likely that the candidate user is in the state of being able to perform an operation to make a payment using a smartphone or the like compared to a case where the candidate user is not utilizing the network service. If the fourth decision method is used as in the example described above, for example, a candidate user that is highly likely to be in the state of being able to perform an operation to make a payment is decided as the requested user.

Some network services may have a function of conveying a state of a user to another user. Examples of the state include “CHATTING”, “AWAY”, and “IN MEETING”. In the case where such a network service is utilized, the deciding unit 102 may decide the requested user on the basis of the state information of a candidate user conveyed by the function. Specifically, not a candidate user who is “AWAY” or “IN MEETING” but a candidate user who is “CHATTING” is decided as the requested user.

### [2-4] Fifth Decision Method

In a fifth decision method, in the case where a candidate user declares whether or not to accept a request, the deciding unit 102 decides a requested user using the content of the declaration as the affecting information. In the exemplary embodiment, the second registered information includes information representing whether or not a candidate accepts a request (hereinafter referred to as “acceptance/refusal information”) declared by the candidate user. For example, the candidate user declares that he/she accepts a payment request if acceptance/refusal information indicating that he/she “accepts” such a payment request is registered, and declares that he/she refuses a payment request if acceptance/refusal information indicating that he/she “refuses” such a payment request is registered. In the case where the second registered information on a candidate user includes acceptance/refusal information indicating that he/she “accepts” a request, the deciding unit 102 determines that the request conditions are met, and decides the candidate user as the requested user.

The acceptance/refusal information is information registered by a candidate user himself/herself, and therefore tends to correctly represent the intention of the candidate user as to whether or not to accept a payment request compared to the attribute of the candidate user or the like.

### [3] Third Exemplary Embodiment

A third exemplary embodiment of the present invention will be described below with focus on differences from the first and second exemplary embodiments. In the first and second exemplary embodiments, it is determined whether or not the request conditions are met on the basis of the affecting information, and a requested user is decided in the case where the request conditions are met. In the third exemplary embodiment, however, a priority is calculated on the basis of the affecting information, and a requested user is decided using the calculated priority. In the following description, a history of interaction between the user and a candidate user and the paying capacity of the candidate user are used as the affecting information.

### [3-1] Functional Configuration

In the exemplary embodiment, the deciding unit 102 stores a first priority table in which the history of interaction and the priority are correlated with each other and a second priority table in which the paying capacity and the priority are correlated with each other.

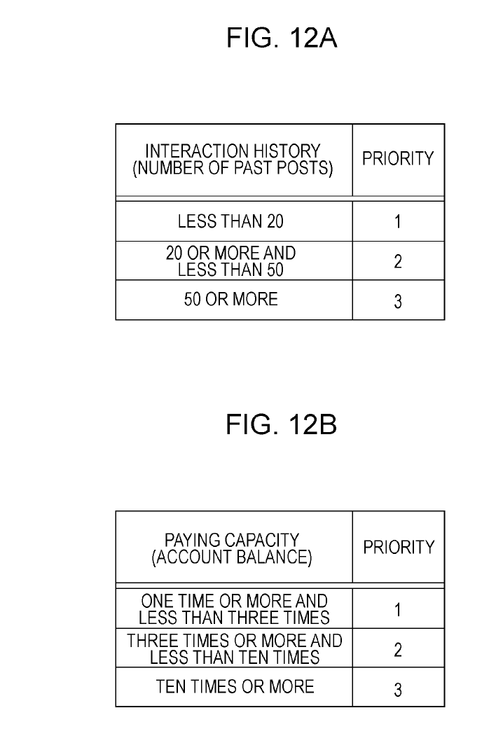

FIGS. 12A and 12B illustrate an example of the first priority table and an example of the second priority table, respectively. In FIG. 12A, the history of interaction (in the example, the number of past posts) “LESS THAN 20”, “20 OR MORE AND LESS THAN 50”, and “50 OR MORE” and the priority “1”, “2”, and “3” are correlated with each other, respectively. In FIG. 12B, the paying capacity (in the example, the ratio between the balance of the account and the service charge) “ONE TIME OR MORE AND LESS THAN THREE TIMES”, “THREE TIMES OR MORE AND LESS THAN TEN TIMES”, and “TEN TIMES OR MORE” and the priority “1”, “2”, and “3” are correlated with each other, respectively.

For example, in the case where the history of interaction (the number of past posts) of a certain candidate user is 25, the deciding unit 102 reads the priority “2”, which is correlated with a history of interaction of 25, that is, “20 OR MORE AND LESS THAN 50”, in the first priority table. In the case where the balance of the account of the candidate user is 15000 yen and the service charge is 1000 yen, meanwhile, the deciding unit 102 reads the priority “3”, which is correlated with a paying capacity of 15 times (15000 yen divided by 1000 yen) in the second priority table. The deciding unit 102 calculates the total of the read priorities (in this case, 2+3=5) as the priority of the candidate user. The deciding unit 102 also calculates a priority for the other candidate users, and decides a predetermined number (for example, three) of candidate users with the largest values of the calculated priority as the requested users.

The deciding unit 102 may use the affecting information such as the attribute of a candidate user, the state information of a candidate user about a network service, and whether or not a candidate user accepts a request besides the history of interaction and the paying capacity, or may use such kinds of the affecting information in various combinations. Alternatively, the deciding unit 102 may use only one kind of the affecting information. Alternatively, the deciding unit 102 may decide candidate users with the second to fourth priorities, for example, as the requested users, or may decide candidate users with even-numbered priorities as the requested users, rather than deciding candidate users with the largest values of the calculated priority as the requested users. In short, the deciding unit 102 may calculate a priority for each candidate user on the basis of the affecting information, and decide the requested user on the basis of the calculated priority.

### [4] Fourth Exemplary Embodiment

A fourth exemplary embodiment of the present invention will be described below with focus on differences from the exemplary embodiments described above. In the fourth exemplary embodiment, in the case where a payment is refused by the requested user, or in the case where a payment is not completed within a predetermined time period, different candidate users are requested to make the payment.

### [4-1] Functional Configuration

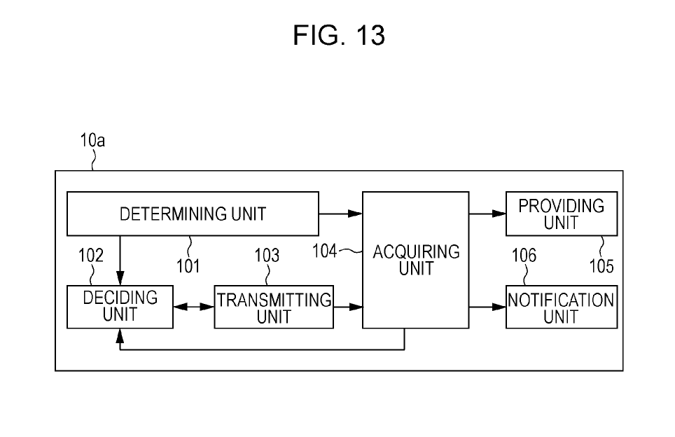

FIG. 13 illustrates an example of the functional configuration of an information processing apparatus according to a fourth exemplary embodiment. In the example, an information processing apparatus 10a includes the units illustrated in FIG. 3 is illustrated. In the exemplary embodiment, the deciding unit 102 first decides requested users using the priority as in the third exemplary embodiment. Specifically, the deciding unit 102 decides three candidate users, for example, with the largest values of the priority calculated using the first and second priority tables illustrated in FIGS. 12A and 12B as requested users.

[4-1-1] Case where Payment is Refused

In the case where the determining unit 101 determines that a payment may not be made by the specific payment method as discussed above, the acquiring unit 104 acquires status information indicating the payment status of a service charge for a paid service by the requested user to whom request data are transmitted by the transmitting unit 103. If refusal data are transmitted from the second user terminal 30, the acquiring unit 104 acquires the refusal data as the status information indicating that the service charge is not paid. In this case, the acquiring unit 104 notifies the deciding unit 102, in addition to the providing unit 105 and the notification unit 106, of a fact that the payment for the service charge is refused together with the service number corresponding to the payment.

In the case where the acquiring unit 104 acquires the status information indicating that the payment is refused by the requested user, the deciding unit 102 decides different requested users. In the exemplary embodiment, in the case where all the three requested users decided as described above refuse the payment, the deciding unit 102 decides three candidate users, for example, with the fourth, fifth, and sixth largest values of the priority calculated using the first and second priority tables as the different requested users.

[4-1-2] Case where Payment is not Completed within Time

In this case, when the request data are transmitted, the transmitting unit 103 notifies the deciding unit 102 of such transmission. In the case where the acquiring unit 104 does not acquire the status information indicating that the service charge is paid within a predetermined time period (for example, one hour or half a day) since the request data are transmitted by the transmitting unit 103, the deciding unit 102 decides different requested users.

In the case where different requested users are decided by the deciding unit 102, either in the case where a payment is refused or in the case where a payment is not completed within a predetermined time period, the transmitting unit 103 transmits the request data to addresses corresponding to the different requested users.

### [4-2] Operation

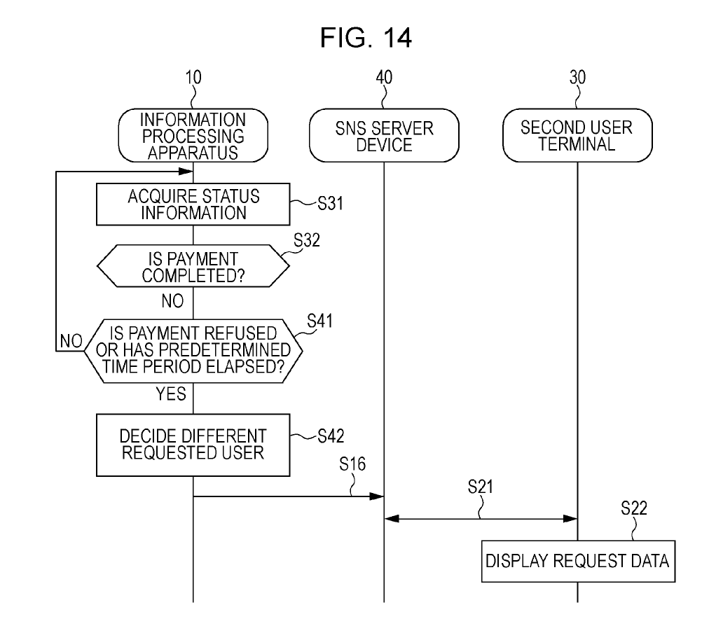

FIG. 14 is a sequence diagram illustrating an example of operation of various devices during the request process according to the exemplary embodiment. In the example, operation in step S31 illustrated in FIG. 11 is performed as operation in the request process. The information processing apparatus 10 first acquires the status information (step S31). The information processing apparatus 10 next determines whether or not the payment is completed on the basis of the acquired status information (step S32). In the case where it is determined that the payment is not completed (NO), it is further determined whether or not the payment is refused or a predetermined time period has elapsed (step S41). In the case where the result of determination in step S41 is negative (NO), the information processing apparatus 10 returns to step S31 to perform the operation. In the case where it is determined in step S41 that the payment is refused or a predetermined time period has elapsed (YES), the information processing apparatus 10 decides different requested users (step S42). Step S42 is performed by the deciding unit 102. After that, operation in and after step S16 illustrated in FIG. 10 is performed.

### [5] Fifth Exemplary Embodiment

A fifth exemplary embodiment of the present invention will be described below with focus on differences from the exemplary embodiments described above. A payment made by the requested user is temporarily made for a service charge that should be paid by the user on behalf of the user.

Thus, the user occasionally pays the service charge temporarily paid by the requested user (hereinafter referred to as “advance money”) to the requested user. In the fifth exemplary embodiment, a payment of the advance money is made by the information processing apparatus 10 on the basis of an operation by the user.

### [5-1] Functional Configuration

In the exemplary embodiment, in the case where there is a payment method that may be utilized by both the user and the requested user (hereinafter referred to as a “common payment method”), the transmitting unit 103 transmits request data indicating that a repayment by the common payment method is desired. Examples of the common payment method include a payment by electronic settlement made using an IC card of a different type from the specific payment method discussed above (in other words, electronic settlement operated by a different business).

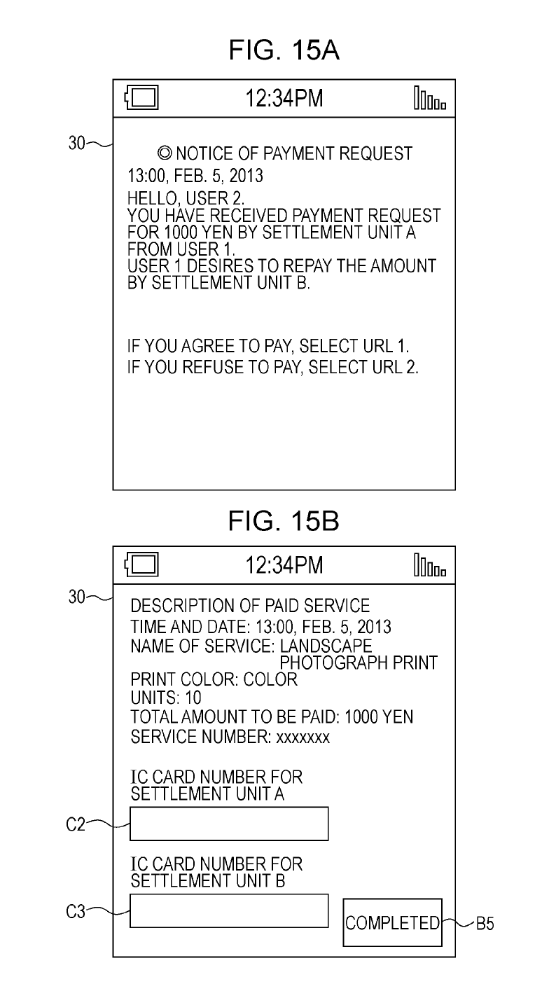

FIGS. 15A and 15B each illustrate an example of the request data used in the exemplary embodiment. In the example of FIG. 15A, a character string “HELLO, USER 2. YOU HAVE RECEIVED PAYMENT REQUEST FOR 1000 YEN BY SETTLEMENT UNIT A FROM USER 1. USER 1 DESIRES TO REPAY THE AMOUNT BY SETTLEMENT UNIT B.” is displayed. “SETTLEMENT UNIT A” represents a settlement unit used for the specific payment method. “SETTLEMENT UNIT B” represents a settlement unit used for the common payment method. If the requested user accepts the payment by selecting the URL 1, display illustrated in FIG. 15B is displayed, for example. In the example of FIG. 15B, character strings “IC CARD NUMBER FOR SETTLEMENT UNIT A” and “IC CARD NUMBER FOR SETTLEMENT UNIT B”, respective input fields C2 and C3, and an operator image B5 for completion of input are displayed on the second user terminal 30 in addition to the “DESCRIPTION OF PAID SERVICE”. When the operator image B5 is selected on the second user terminal 30, the IC card number input to the input field C3 is transmitted to the information processing apparatus 10, for example.

When the IC card number of the requested user is received, the transmitting unit 103 transmits payment data for the user to pay the service charge for the paid service to the requested user by the common payment method, to an address corresponding to the common payment method. The payment data are data indicating the IC card number of the user, the IC card number of the requested user, and the advance money used in the electronic settlement B, for example. The IC card number of the user has been input by the user in the pre-payment operation, for example. The address corresponding to the common payment method is an address to be accessed by an external device to access an electronic settlement system that provides the electronic settlement B, for example. In the exemplary embodiment, the transmitting unit 103 stores such an address to be accessed in correlation with each payment unit. When the payment data are received, and if the balance of electronic money correlated with the IC card number of the user is equal to or more than the advance money, the electronic settlement system used for the common payment method subtracts the advance money from the balance of the electronic money, and adds the advance money to the balance of electronic money correlated with the IC card number of the requested user. In this way, the advance money is repaid by the electronic settlement B.

### [6] Modifications

Each of the exemplary embodiments discussed above is merely exemplary of the present invention, and may be modified as follows. Each of the exemplary embodiments discussed above and each of the modifications described below may be implemented in combination as necessary.

### [6-1] Advance Payment of Service Charge

In the common payment method discussed in the fifth exemplary embodiment, if it is possible for the user to make a payment for a charge in advance (a so-called advance payment) to the requested user, the requested user may be decided by a method other than that described above. For example, the electronic settlement system used for the common payment method provides a service for receiving an advance payment at a site that is viewable via the network 2. For example, when the user accesses the site by operating the first user terminal 20 or the like and performs an operation to pay a charge that he/she desires to pay in advance, the electronic settlement system transfers electronic money for an amount of the charge from the balance of electronic money of the user to the balance of electronic money of the requested user to make an advance payment.

In the modification, the deciding unit 102 decides the requested user using whether or not he/she has been paid for a charge by the user in advance as the affecting information. For example, the deciding unit 102 decides a candidate user who has been paid for an amount of the service charge or more by the user in advance as the requested user. Alternatively, the deciding unit 102 may decide a candidate user who has been paid for a larger amount by the user in advance as the requested user with a higher priority. In either case, the requested user which is requested to make a payment has been paid for a charge by the user in advance, that is, an advance payment has been made to the requested user, and therefore tends to accept a payment request compared to a case where an advance payment has not been made. For the user, meanwhile, it is more likely that a payment request is accepted compared to a case where whether or not there is any charge paid in advance (that is, there is any advance payment) is not used as the affecting information. Thus, there is a less possibility that the payment request is refused and it takes time to make a request of another requested user, which allows the user to quickly utilize the paid service.

### [6-2. Repayment Method]

In the fifth exemplary embodiment, the user repays the advance money in cash. However, the present invention is not limited thereto, and the advance money may be repaid using points that may be utilized as electronic money, for example, or may be repaid, in the case where there is a network service (for example, a movie viewing service) of an SNS or the like that both the users use and that is available only for a limited period of time, by extending the available period of time. In such cases, repayment is made by the transmitting unit 103 by transmitting data indicating the points for a repayment or the period of time for extension to a system that manages such points or a system that manages the available time of the service, for example.

### [6-3] Method of Determining Whether or not Specific Payment Method is Available

The determining unit 101 may perform a determination by a method that is different from that discussed in the exemplary embodiments described above. For example, the determining unit 101 stores second registered information including information indicating whether or not a specific payment method is available to a user (hereinafter referred to as “availability/unavailability information”). The availability/unavailability information may be registered by the user, or may be determined on the basis of the second registered information and registered by a business that provides a paid service. In the case where a paid service is provided to the user with a user ID etc. input, the determining unit 101 performs a determination on the basis of the availability/unavailability information registered as the second registered information together with the user ID etc. (specifically, it is determined that the user may make a payment by the specific payment method if the registered availability/unavailability information indicates that the specific payment method is available).

Meanwhile, the determining unit 101 may perform a determination on the basis of the amount that may be paid by the specific payment method by the user. For example, the determining unit 101 determines that the user is not able to make a payment by the specific payment method in the case where information indicating the amount that may be electronically settled by the user is acquired by making an inquiry to an electronic settlement system used for the specific payment method and if the amount indicated by the thus acquired information is less than a service charge.

### [6-4] Method of Deciding Requested User

The deciding unit 102 may perform a decision by a method that is different from that discussed in the exemplary embodiments described above. For example, the user registers a group to which candidate users belong, and the deciding unit 102 decides candidate users belonging to the group as requested users. In this case, if plural groups are registered, the deciding unit 102 may only decide which group a request is made for. For example, in the case where three groups α, β, and γ are registered, the deciding unit 102 decides candidate users belonging to a group to which the largest number of candidate users that meet the request conditions belong as requested users.

Examples of the group include family members, colleagues, and persons who use the same service as the user's as discussed in relation to the example of FIG. 5. Besides, candidate users gathered for the purpose of temporarily paying a service charge may be treated as a group. In this case, money collected from the candidate users may be pooled in an account so that the requested user belonging to the group may use the money to pay a service charge. In the modification, the user may register persons to whom the user feels comfortable to request a payment, persons who seem to be financially affluent, or the like in a group so that such persons tend to be decided as the requested users.

In the case where the attribute of each group is registered and the priority of each attribute is decided, the deciding unit 102 may decide a group for which a request is made on the basis of the attribute of the group, that is, decide candidate users who belong to the group as requested users. For example, in the case where the request conditions discussed above are determined for each of the candidate users, the load of the determination process may be enormous if the number of candidate users is increased. However, the load is reduced if the determination is made on the basis of the attribute of the group.

### [6-5] Impetus to Decide Different Requested User

In the fourth exemplary embodiment, the deciding unit 102 decides different requested users with refusal by the requested user to make a payment or non-completion of a payment within a predetermined time period as an impetus. However, different requested users may be decided with other impetuses. For example, the deciding unit 102 decides different requested users in the case where the decided requested user logs out from the SNS. In this case, the deciding unit 102 logs in to the SNS to reference the account of the requested user as discussed in relation to the second exemplary embodiment, and decides different requested users in the case where the account is turned from the log-in state to the log-off state.

In a different configuration, in the case where plural requested users are decided, the deciding unit 102 may wait for a payment for different periods of time for the requested users, and different requested users may be decided sequentially as the periods of time elapse. For example, it is assumed that the deciding unit 102 waits for one, two, and three hours for users 1, 2, and 3, respectively, to make a payment. If one hour elapses with the user 1 making no payment, the deciding unit 102 decides a user 4 as a different requested user. If two hours elapses with the user 2 making no payment, the deciding unit 102 decides a user 5 as a different requested user.

### [6-6] Method of Notifying User

In each of the exemplary embodiments described above, the information processing apparatus 10 notifies the user of the payment status of a service charge. However, the present invention is not limited thereto, and the SNS server device 40 or the service server device 50 may notify the user of the payment status, for example. Alternatively, an electronic settlement system used for the specific payment method may notify the user of the payment status. In either case, the user may be notified of the payment status in the case where the device that makes a notification acquires status information indicating the payment status and the status information indicates that a payment has been completed. In such cases, the information processing apparatus may not include the notification unit 106.

### [6-7] Method of Paying Service Charge

The method in which the requested user pays a service charge is not limited to that discussed above. For example, when a URL indicated by the request data is accessed, information indicating the content of paid services associated with the user is displayed, and when the requested user selects one of the paid services for which he/she makes a payment, a payment site such as that illustrated in FIG. 7 is displayed to make the payment.

When the requested user makes a payment, certification data certifying that a payment is completed may be transmitted to the second user terminal 30, which may deliver the certification data to the information processing apparatus 10 by way of the first user terminal 20 so that the information processing apparatus 10 provides a paid service.
[6-8] Address to which Request Data are Transmitted

In each of the exemplary embodiments discussed above, the transmitting unit 103 transmits request data to an address corresponding to the requested user decided by the deciding unit 102. However, the present invention is not limited thereto, and the transmitting unit 103 may transmit request data to an address decided in advance, for example. For example, there may be a settlement unit for temporary payment used commonly by users who use a paid service, and the transmitting unit 103 may transmit request data to an address prepared to request a payment using the settlement unit. Alternatively, the transmitting unit 103 may transmit request data to an address indicated by an external device. In short, the transmitting unit 103 may transmit request data to any address as long as a requested payment is to be made. In the modification, the information processing apparatus may not include the deciding unit 102.

### [6-9] Provision of Paid Service by External Device

The information processing apparatus may not include the providing unit 105. For example, there is a case where a paid service may be provided to the user without being output to a medium. In such a case, a paid service is provided by transmitting result data from the service server device 50 to the first user terminal 20, and thus the information processing apparatus may not include the providing unit 105. Also in this case, a request is made to provide a service, the charge for which is to be paid by a designated method, to a user who is unable to pay the charge by the designated method by the transmitting unit 103 of the information processing apparatus by transmitting request data.

### [6-10] Provision of Mail-Order Trading as Paid Service

In the information processing system, mail-order trading may be provided as a paid service. In this case, the information processing apparatus provides a paid service to the user by exchanging data with the first user terminal 20 via the network 2, rather than being directly operated by the user. Also in this case, a request is made to provide a service, the charge for which is to be paid by a designated method, to a user who is unable to pay the charge by the designated method by the information processing apparatus by deciding a requested user and transmitting request data to the requested user. In addition, the information processing apparatus may transmit request data utilizing an account for interaction between users registered for mail-order trading, for example, in place of transmitting request data utilizing an SNS account or an electronic mail address. Interaction between the users is performed by posting word-of-mouse information or the like, for example.

### [6-11] Operation Corresponding to Certain Matter

Tables used in operation described in relation to FIGS. 5, 12A, and 12B are not limited to those illustrated in such drawings. For example, the number of rows of the tables may be any number that is two or more. In addition, elements arranged in the ascending order (or the descending order) may be rearranged in the descending order (or the ascending order, or may be rearranged regardless of such orders of the elements. The content of each cell may be represented by a numerical value calculated using a formula without using the tables. In the example of FIG. 12A, for example, a value obtained by dividing the history of interaction by 20 may be calculated as the priority. In this case, if the history of interaction has a value of 40, the priority is two, and if the history of interaction has a value of 30, the priority is 1.5. In short, in operation, a certain matter (in the example of FIG. 12A, the priority) may be decided in accordance with a different matter (in the example of FIG. 12A, the history of interaction).

### [6-12] Category of the Invention

The present invention is construed not only as an information processing apparatus and an information processing system including the information processing apparatus, but also as an information processing method for implementation of a process performed by a device such as the information processing apparatus. Examples of the process include the billing process illustrated in FIG. 10. The present invention is also construed as a program that causes a computer such as the information processing apparatus to function as the units illustrated in FIG. 3 etc. The program may be provided in the form of a recording medium such as an optical disc that stores the program, downloaded to a computer via a network such as the Internet and installed to become usable, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a determining unit that determines whether a user who uses a paid service, a charge for which is to be paid by a specific payment method, is able to pay the charge for the service by the specific payment method; and
a transmitting unit that, in the case where the determining unit determines that the user is unable to pay the charge, transmits a request data indicating a content of the request to a requested user who is requested to pay the charge for the service.

2. The information processing apparatus according to claim 1, further comprising:
a deciding unit that decides the requested user from candidate users who are candidates for the requested user on the basis of an affecting information that possibly affects the request,
wherein the transmitting unit transmits the request data to the requested user decided by the deciding unit.

3. The information processing apparatus according to claim 2,
wherein the deciding unit makes the decision using an attribute of the candidate users as the affecting information.

4. The information processing apparatus according to claim 2,
wherein the deciding unit makes the decision using a history of interaction between the user and the candidate users as the affecting information.

5. The information processing apparatus according to claim 2,
wherein the deciding unit makes the decision using a paying capacity of the candidate users by the payment method as the affecting information.

6. The information processing apparatus according to claim 2,
wherein the deciding unit makes the decision using a state information of the candidate users about a service to be utilized via a network as the affecting information.

7. The information processing apparatus according to claim 2,
wherein when the candidate users declare whether to accept the request, the deciding unit makes the decision using a content of the declaration as the affecting information.

8. The information processing apparatus according to claim 2, further comprising:
an acquiring unit that acquires status information indicating a status of payment for the charge for the service by the requested user to which the request data are transmitted by the transmitting unit,
wherein the deciding unit decides a different requested user in the case where the acquiring unit does not acquire the status information indicating that the charge for the service is paid within a predetermined time period since the transmitting unit transmitted the request data, and
the transmitting unit transmits the request data to the different requested user when the deciding unit decides the different requested user.

9. The information processing apparatus according to claim 8, further comprising:
a notification unit that notifies the user of the status of payment for the charge for the service acquired by the acquiring unit.

10. The information processing apparatus according to claim 2,
wherein in the case where there is a payment method that is available to both of the user and the requested user, the transmitting unit transmits to an address corresponding to the payment method, a payment data which is used to pay the charge for the service to the requested user by the user by the payment method.

11. The information processing apparatus according to claim 10,
wherein the payment method that is available to both of the user and the requested user enables the user to pay a charge to the requested user in advance, and
the deciding unit makes the decision using whether the user has paid a charge in advance as the affecting information.

12. A non-transitory computer readable medium storing a program causing a computer to function as:
a determining unit that determines whether a user who uses a paid service, a charge for which is to be paid by a specific payment method, is able to pay the charge for the service by the specific payment method; and
a transmitting unit that, in the case where the determining unit determines that the user is unable to pay the charge, transmits a request data indicating a content of the request to a requested user who is requested to pay the charge for the service.
